(19) United States
(12) Patent Application Publication
(10) Pub. No.: US 2026/0212341 A1
(43) Pub. Date: Jul. 23, 2026

(54) SYSTEMS AND METHODS FOR VIRTUAL CARD DECLINE NOTIFICATIONS

(71) Applicant: Capital One Services, LLC, McLean, VA (US)

(72) Inventors: Vignesh Ramanathan, Herndon, VA (US); Kevin Sweet, Washington, DC (US)

(21) Appl. No.: 19/570,007

(22) Filed: Mar. 17, 2026

Related U.S. Application Data
(63) Continuation of application No. 18/315,604, filed on May 11, 2023.

(51) Int. Cl. G06Q 20/34

(52) U.S. Cl. CPC G06Q 20/351

(57) ABSTRACT

A computer-implemented method, system, and non-transitory computer-readable medium for dynamically triaging declined virtual card transactions. A notification system receives declination data regarding a plurality of declined transactions using prefunded virtual cards, where each prefunded virtual card comprises a string of digits configured for digital online transactions. The notification system determines a decline reason for each declined transaction using rules-based decisioning and computes a severity rating for each declined transaction based on the decline reason. A first interactive graphical user interface comprising an interactive list view displays the declined transactions organized according to the computed severity ratings and is transmitted to an administrator device. Upon receiving an indication that at least one declined transaction has been resolved, the notification system dynamically re-computes updated severity ratings for remaining unresolved declined transactions and generates an updated interactive list view reorganized according to the updated severity ratings.

### CROSS-REFERENCE TO RELATED APPLICATIONS

This application is a continuation of, and claims priority under 35 U.S.C. § 120 to, U.S. patent application Ser. No. 18/315,604, filed May 11, 2023, the entire contents of which are fully incorporated herein by reference.

### FIELD

The disclosed technology relates to systems and methods for virtual card decline notifications. Specifically, this disclosed technology relates to systems for generating graphical user interfaces that enable a client device to receive notifications of declines, respond to the notifications, and interact with a backend notification system.

### BACKGROUND

In large scale commercial credit lending systems, traditional lines of credit and/or credit cards can be replaced with virtual cards. These virtual cards can be for limited purposes, for example they can be linked to a specific vendor, can be prefunded with a specific amount of funds, and/or can be useable for only a predetermined period of time. A commercial client can issue these virtual cards to vendors to use for those limited purposes. Problems exist, however, when responding to situations where the vendor attempts to use the card and issues occur with the attempted transaction.

These problems can be a bottleneck for the client and vendor alike. For example, when a decline takes place, vendors can call the client for help, and the vendor and/or client can escalate the problem to a support team at the commercial lender. The problematic end result is anxiety, confusion, and wasted time for the unaware client, expectant vendor, and lender. Accordingly, there is a need for improved systems and methods for virtual card decline notifications. Embodiments of the present disclosure are directed to this and other considerations.

### SUMMARY

Disclosed embodiments can include a system for virtual card decline notifications. The system can include one or more processors, and memory in communication with the one or more processors and storing instructions that, when executed by the one or more processors, are configured to cause the system to provide virtual card decline notifications. The system can receive declination data regarding a first transaction using a prefunded virtual card. The system can determine, from the declination data, a reason the prefunded virtual card was declined using rules-based decisioning. The system can categorize the reason into one of one or more predetermined categories. Responsive to the reason being categorized in a select group of the one or more predetermined categories, the system can generate a first interactive graphical user interface including an interactive list view showing one or more previous declined transactions using prefunded virtual cards, transmit the first interactive graphical user interface to an administrator device for display, receive a first request for first information regarding the first transaction by selecting the first transaction utilizing the first interactive graphical user interface from the administrator device, generate a second interactive graphical user interface including a detailed view of the first transaction showing the reason, the declination data, card data, a card balance, and a card view link, and transmit the second interactive graphical user interface the administrator device for display.

Disclosed embodiments can include a system for virtual card decline notifications. The system can include one or more processors, and memory in communication with the one or more processors and storing instructions that, when executed by the one or more processors, are configured to cause the system to provide virtual card decline notifications. The system can receive first declination data regarding a first transaction using a first prefunded virtual card. The system can determine, from the first declination data, a first reason the first prefunded virtual card was declined using rules-based decisioning. The first reason can be categorized as a first type. Responsive to the first reason being categorized as the first type, the system can generate a first interactive graphical user interface showing the first reason, transmit the first interactive graphical user interface to a first administrator device, and send a first email notifying all administrator devices of the first declination data regarding the first transaction and the first reason. The system can receive second declination data regarding a second transaction using a second prefunded virtual card. The system can determine, from the second declination data, a second reason the second prefunded virtual card was declined using rules-based decisioning. The second reason can be categorized as a second type. Responsive to the second reason being categorized as the second type, the system can generate a second interactive graphical user interface showing the second reason, transmit the second interactive graphical user interface to a second administrator device, and send a second email notifying all administrator devices of the second declination data regarding the second transaction and the second reason.

Disclosed embodiments can include a system for virtual card decline notifications. The system can include one or more processors, and memory in communication with the one or more processors and storing instructions that, when executed by the one or more processors, are configured to cause the system to provide virtual card decline notifications. The system can receive declination data regarding a first transaction using a prefunded virtual card. The system can determine, from the declination data, a reason the prefunded virtual card was declined using rules-based decisioning. The reason can be categorized as a first type of one or more types. Responsive to the reason being categorized as the first type, the system can determine a ranking of one or more previous declined transactions using prefunded cards and the first transaction using the reason and the declination data, notify an administrator device regarding the first transaction, generate a first interactive graphical user interface comprising an interactive notification list view comprising the previous declined transactions and the first transaction in a first order according to the ranking, transmit the first interactive graphical user interface to the administrator device for display, receive, from the administrator device, an indication that one or more transactions had been resolved, determine an updated ranking of the one or more previous declined transactions and the first transaction compensating for the indication, generate an updated first interactive graphical user interface comprising an updated interactive notification list view comprising the previous declined transactions and the first transaction in a second order according to the updated ranking, and transmit the updated first interactive graphical user interface to the administrator device for display.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1A is a flow diagram illustrating an exemplary method for virtual card decline notifications, in accordance with certain embodiments of the disclosed technology.

FIG. 1B is a flow diagram illustrating an exemplary method for virtual card decline notifications, in accordance with certain embodiments of the disclosed technology.

FIG. 2 is a flow diagram illustrating an exemplary method for virtual card decline notifications, in accordance with certain embodiments of the disclosed technology.

FIG. 3 is block diagram of an example notification system used to provide virtual card decline notifications, in accordance with certain embodiments of the disclosed technology.

FIG. 4 is block diagram of an example system that can be used to provide virtual card decline notifications, in accordance with certain embodiments of the disclosed technology.

### DETAILED DESCRIPTION

Examples of the present disclosure related to systems and methods for virtual card decline notifications. The systems and methods described herein utilize, in some instances, graphical user interfaces, which are necessarily rooted in computers and technology. Graphical user interfaces are a computer technology that allows for user interaction with computers through touch, pointing devices, or other means. The present disclosure details providing interactable graphical user interfaces that provide a client and/or administrator device with the ability to review and respond to notifications that describe issues with a virtual card provided to a vendor. This, in some examples, can involve using rules-based decisioning to determine, from declination data, a reason the prefunded virtual card was declined so as to dynamically change the graphical user interface to provide a detailed view of the transaction showing the reason for the decline, declination data, card data, a card balance, and a card view link for the client/administrator to easily respond and resolve the issue. Using a graphical user interface in this way can allow the system to bypass the need for additional, analog human involvement, such as needing to call a service center associated with the commercial lender for the virtual card. This is a clear advantage and improvement over prior technologies that simply wait until a problem happens, send one notification of a decline, and require the vendor and/or client/administrator to call a service line to have an issue resolved. The present disclosure solves this problem by providing notifications of reasons for issues associated with the virtual card, and by also allowing the system to learn from any decline that previously occurred so as to obviate future declines—i.e., the system is able to not only resolve the issue, but also learn to avoid the issue in the future. Overall, the systems and methods disclosed have significant practical applications in the data processing field because of the noteworthy improvements of the bypassing of manual methods of dealing with digital transaction errors, which are important to solving present problems with this technology.

The systems and methods described herein also can utilize, in some instances, machine learning models, which are necessarily rooted in computers and technology. Machine learning models are a unique computer technology that involves training models to complete tasks and make decisions. The present disclosure details providing interactable graphical user interfaces that provide a client and/or administrator device with the ability to review and respond to notifications that describe issues with a virtual card provided to a vendor. This, in some examples, can involve using (i) past declination data and (ii) a reason the prefunded virtual card was declined using rules-based decisioning as inputs to a heuristic machine learning model, so as to automatically apply an automatic resolution to correct the reason the prefunded virtual card was declined. The model can help the system to output an interactive graphical user interface showing the reason and the automatic resolution. Using a machine learning model in this way can allow the system to obviate issues before they happen, thereby removing the entire method from the realm of mental processes—i.e., the system is able to not only automatically resolve the issue, but also learn to avoid the issue in the future. This is a clear advantage and improvement over prior technologies that simply wait until a problem happens, send one notification of a decline, and require the vendor and/or client/administrator to call a service line to have an issue resolved. Furthermore, examples of the present disclosure can also improve the speed with which computers can operate because, instead of hosting resources for call centers, error notification systems, and the like, the system can process errors and resolve them without excess network traffic between the different stakeholders (i.e., vendor, client/administrator, lender, etc.). Overall, the systems and methods disclosed have significant practical applications in the network and data management field because of the noteworthy improvements, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

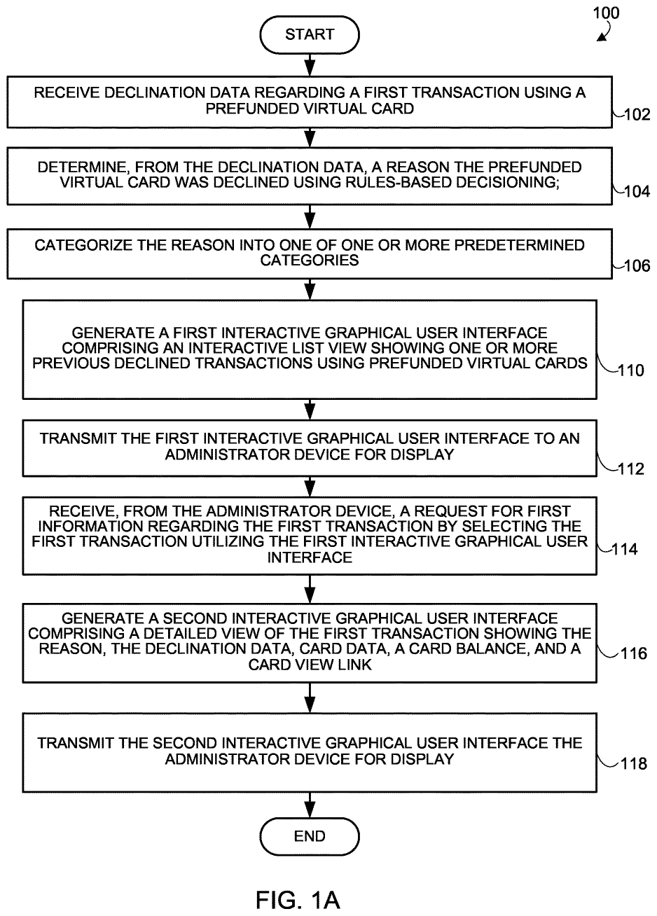

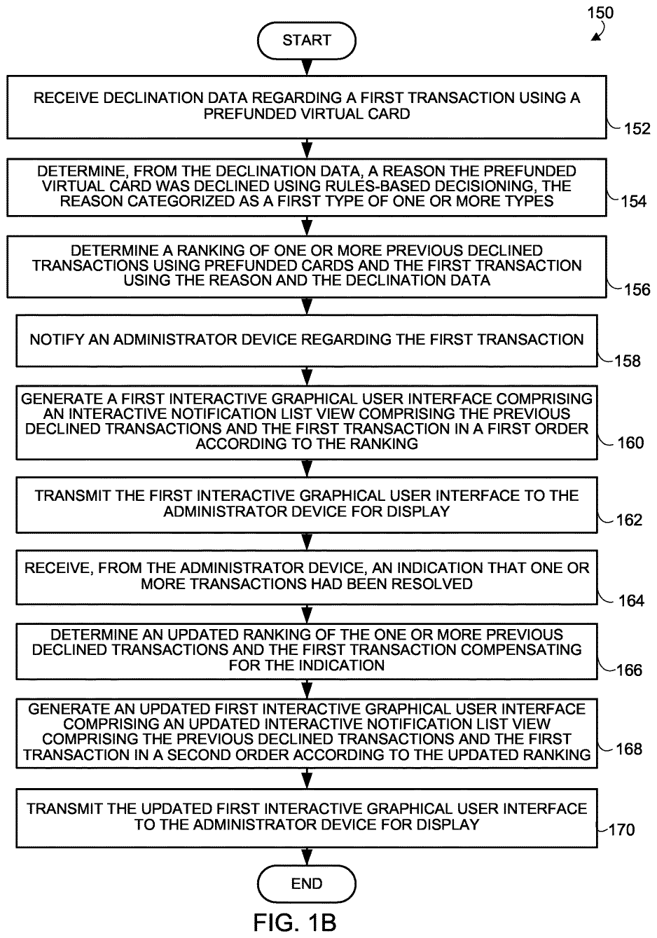

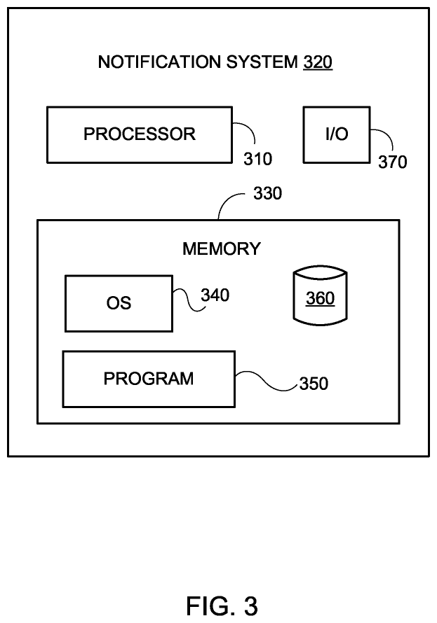

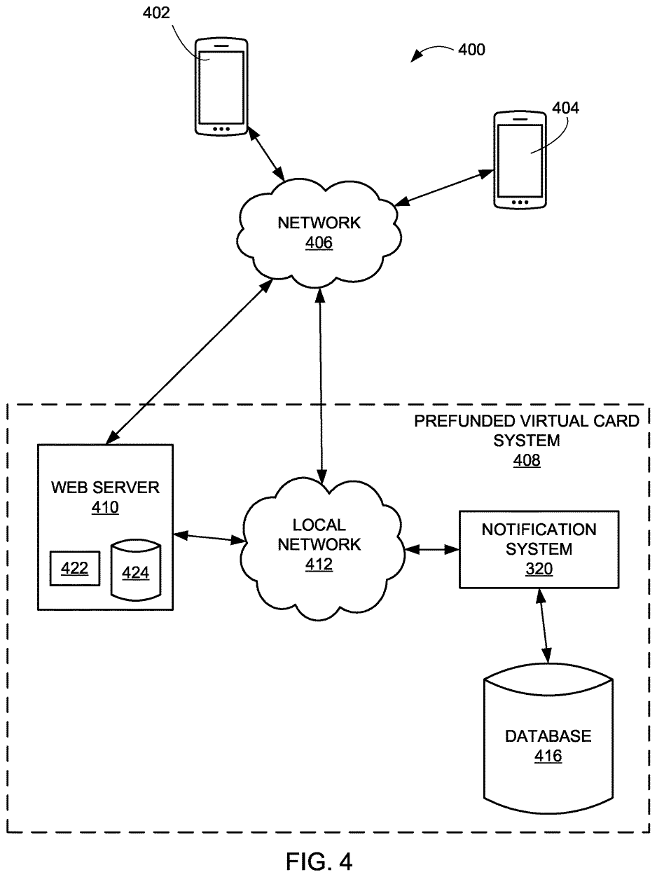

FIG. 1A is a diagram illustrating an exemplary method 100 for virtual card decline notifications, in accordance with certain embodiments of the disclosed technology. The steps of method 100 can be performed by one or more components of the system 400 (e.g., via notification system 320, web server 410 of prefunded virtual card system 408, or user device 402), as described in more detail with respect to FIGS. 3 and 4. In block 102, the notification system 320 can receive declination data regarding a first transaction using a prefunded virtual card. A prefunded virtual card can be a card that is provided to a client, from a commercial lender for example, for a limited purposes so that the client can then provide this limited-purpose virtual card to a vendor. To use an example, a client may be a general contractor that hires a plumber and a framer for a job. The plumber may need to purchase equipment and supplies to complete this job, and that purchase amount is estimated to be, for example, $10,000. The prefunded virtual card can, therefore, have a $10,000 prefunded amount of credit. The prefunded virtual card can also have a temporal aspect, in that the card may only be active for a predetermined period of time. In some examples, the virtual card can also have a predefined type of purchase that can be made. For example, a virtual card for a plumber can be limited to make purchases only at merchants that are relevant to plumbing. This limited transaction type can be set by comparing where the virtual card was being used to a list of merchant types, for example by using merchant category codes (MCCs). Another aspect of virtual cards is that they are not represented as physical cards but can only be used online, i.e., by running the card digitally. The virtual card can include a typical card number, e.g., a 16-digit number that links the card to a prefunded account, and that card number can be used in digital payment systems to effect a payment.

Referring now to the declination data, the data can include information about why the first transaction using the prefunded virtual card may have been declined. Types of declines typically fall into one or more particular categories, as will be described below. These types of categories can help to (a) alert a vendor as to how to address an issue with the card and/or (b) train a machine learning model to automatically address the issue with the prefunded virtual card.

Referring again to method 100, in block 104, the notification system 320 can determine, from the declination data, a reason the prefunded virtual card was declined using rules-based decisioning. The rules-based decisioning can be one or more rules agreed to by the client and lender in order to provide the prefunded card to a vendor. These rules can be based on the specific purpose of the card (e.g., limit amount, limited time, limited merchant, etc.), and/or the rules can be rules set by the commercial lender for security purposes. For example, card verification values (“CVVs”) can be used in virtual cards as well so as to ensure that the card numbers linked to the prefunded account are protected any only available to people who can input the CVV along with any card numbers associated with the prefunded virtual card. The rules-based decisioning can determining a reason that a transaction using the prefunded virtual card may have been declined, and the decisioning can also assess potential problems associated with that particular reason, as will be described below.

In block 106, the notification system 320 can categorize the reason into one of one or more predetermined categories. The system, using the rules-based decisioning, can determine what type of issue caused the card decline, and the type of issue (i.e., a category of reasons for decline) can be used later to inform the client/vendor/lender of the issue and also take steps to resolve the issue. Table 1 below illustrates potential reasons that the decline may happen, the potential issue(s) that can cause that decline reason, and potential resolutions that can help overcome the reason(s), noting the list is not limiting.

TABLE 1

| | Issue Associated | Potential Resolution |
|---|---|---|
| Potential Reason | with Reason | Recommendation |
| Above Card | Ran for more than | Share remaining |
| Limit | prefunded amount | amount to vendor |
| Exact Pay | Swiped for less than | Change setting or |
| | amount available | explain to vendor |
| Expiration Date | Entered date did not | Try again |
| Mismatch | match expected date | |
| Expired Card | Card is expired | Create new card (i.e., |
| | | virtual card number) |
| CVV Mismatch | Entered CVV did not | Try again |
| | match expected CVV | |

Referring specifically to Table 1, in one example, the reason for decline may be that the card was run (e.g., digitally “swiped” at an online checkout) for an amount over the prefunded amount. Considering the example above for the plumber vendor, this can include a scenario where the vendor runs the card for $11,000, which is $1,000 over the prefunded amount of $10,000. This reason can provide information to the client that either the vendor is going beyond what was necessary to fulfill the agreed-to limited services, or that the prefunded amount was too low in the first place. A potential resolution to that decline reason can include pooling funds from another prefunded virtual card, or pooling funds from a master account held by the client, and then sharing the pooled funds with the declined vendor's prefunded virtual card so as to finalize payment.

The issues related to the reason associated with the transaction being above a card limit can also include situations where the card decline is a result of a transaction being not only above a card limit but also above funds held by the master account. For example, in a first scenario, if the transaction amount is greater than the funds available on the card, the potential resolution can be that the vendor or client reconcile books, the card is cancelled, and/or the vendor swipes again for a corrected amount. In a second scenario, the transaction amount may be greater than the funds available on the master account. Here, the potential resolution may be that the vendor or client reconcile books, the client and/or prefunded virtual cart system 408 administrator addresses oversettled transaction, the card is cancelled, and/or the vendor swipes for a corrected amount.

Another reason can include that “exact pay” was allocated to that particular virtual card, meaning that the purpose for the particular virtual card was limited to a specific amount, and that amount is different than the amount being requested by the merchant using that prefunded virtual card. A potential resolution to that decline reason can include requesting, via a graphical user interface transmitted to the vendor, that the exact-pay setting be altered so that the payment can proceed. The issues related to the reason associated with exact pay issues can include situations where the transaction amount is higher than “exact pay” amount. Here, the potential resolution can include that the vendor or client reconcile books, the card is cancelled, and/or the vendor swipes again for a corrected amount. In another scenario, the issue associated with the reason can include that the transaction amount is lower than “exact pay” amount. In this scenario, the potential resolution can include that vendor or client reconcile books, the card is cancelled, the vendor swipes for correct amount, and/or exact pay is disabled allowing for smaller transaction amounts (if for example vendor needs to process individual invoices).

Another reason can include that the expiration date of the limited purposes prefunded virtual card entered by the vendor does not match the expiration number associated with the virtual card, meaning that this could be an error, or it could be potential fraud. A potential resolution to that decline reason can include requesting the vendor to re-enter the expiration information and potentially alerting the client of same. To further elaborate, issues related to the reason associated with expiration date mismatch can include situations where the expiration date entered during transaction does not match system information. Here, the potential resolution can include the individual running the transaction (e.g., vendor) self corrects a typographical error or reaches out to a client to retrieve latest card information.

Another reason can include that the expiration date of the limited purposes prefunded virtual card has passed, meaning that the limited purposes timeframe of that card has passed. The client can be notified of this information, and the potential resolution to that decline reason can include creating a new card (i.e., virtual card number). To further elaborate, issues related to the reason associated with expired card issues can include situations where the transaction made on expired card that is funded. Here, the potential resolution can include that the vendor and client communicates, the client extends card or cancels the card, and/or the client sends a new card to the vendor. In another scenario, the issue associated with the reason can include that the transaction made on expired card that is not funded. In this scenario, the potential resolution can include that the vendor and client communicates, and a new payment sent if appropriate.

Another reason can include that the CVV of the limited purposes prefunded virtual card entered by the vendor does not match the CVV number associated with the virtual card, meaning that this could be an error, or it could be potential fraud. A potential resolution to that decline reason can include requesting the vendor to re-enter the CVV information and potentially alerting the client of same. In some examples, the reasons can include any combination of the above reasons or any other reason, as will be appreciated. To further elaborate, issues related to the reason associated with a CVV mismatch can include situations where the expiration date entered during transaction does not match system information. Here, the potential resolution can include the individual running the transaction (e.g., vendor) self corrects a typographical error or reaches out to a client to retrieve latest card information.

Referring again to method 100, in block 110, the notification system 320 can generate a first interactive graphical user interface including an interactive list view showing one or more previous declined transactions using prefunded virtual cards. This generate step can be responsive to the reason being categorized as described above. In this step, the notification system 320 can create a detailed list of all virtual card numbers operated by the client so that the client can review any issues with the one or more cards. For instance, and using the example described above, the client may be a general contractor that hires a plumber and a framer for a job. Any declines for either the framer or the plumber can be generated in the graphical user interface for easy access and review by the client.

In block 112, the notification system 320 can transmit the first interactive graphical user interface to an administrator device for display. The administrator device can be a single client that has issued one or more virtual cards, for example a small business that issues virtual cards and has only one single point of contact that manages the various virtual cards. In other examples, the administrator device can be associated with a large entity that issues a large quantity of prefunded virtual cards to a large quantity of vendors. This could include for example a large construction organization that has hundreds of sub-contractors that complete work, and each of those sub-contractors can have a prefunded virtual card for each job. In those examples, the client may delegate different services, or decline reasons, to different individuals based on expertise. For example, one administrator device associated with one worker may be in charge of reviewing declines for plumbing vendors while another administrator device associated with another worker may be in charge of reviewing declines for framing vendors. In this case, the first interactive graphical user interface can be tailored specifically for that administrator device's predetermined specialty. In another example, one administrator device associated with one worker may be in charge of reviewing declines for a first reason (e.g., exact pay declines), while another administrator device associated with another worker may be in charge of reviewing declines for a second reason (e.g., transactions above a card limit). In this case, the first interactive graphical user interface can be tailored specifically for that administrator device's predetermined decline reason.

In block 114, the notification system 320 can receive, from the administrator device, a first request for first information regarding the first transaction by selecting the first transaction utilizing the first interactive graphical user interface. In block 116, the notification system 320 can generate a second interactive graphical user interface including a detailed view of the first transaction showing the reason, the declination data, card data, a card balance, and a card view link. The card view link can generate specific information about that particular virtual card. In block 118, the notification system 320 can transmit the second interactive graphical user interface the administrator device for display. In some examples, the first interactive graphical user interface and the second interactive graphical user interface can be a part of an email, a push notification, a message, or combinations thereof. In some examples, the first interactive graphical user interface and the second interactive graphical user interface can be part of an application on the administrator device.

In some examples, the notification system 320 can determine a severity rating for each of the one or more previous declined transactions based on the predetermined category. The first or second interactive graphical user interface can then be organized based on the severity rating. The severity rating can be based on, for example, one or more of a ranking of how much over the prefunded amount the decline transaction is ran for, how far beyond the expiration date the decline transaction is ran for, etc. This data can help the administrator device to triage any issues. In some examples, in response to receiving the first request from the administrator device regarding the first transaction, the notification system 320 can assess receipt of that first request as an indication that issues regarding the first transaction (and related information such as the reason, the declination data, etc.) have a higher severity rating that other issues. In this case, a machine learning model can learn from the first request to re-rank the severity ratings in the interactive list view in the future.

In some examples, the notification system 320 can determine a numerical order of virtual card numbers associated with the one or more previous declined transactions. The notification system 320 can then organize the interactive list view based on the numerical order of virtual card numbers. In this scenario, the commercial lender (e.g., virtual card issuer), can base the virtual card numbers in an order that can be recognized by the administrator device. For example, and as described above, the virtual card number can be a string of digits, and in some cases, this can be a substantially random string of digits (e.g., created by a random number generator). But in some examples, the virtual card number can be a string of digits that can incorporate certain identifiers about the client and/or vendor. In one case, the virtual number may indicate a hierarchy of vendors so that the interactive list view is based on a numerical order of the particular vendors.

In some examples, the notification system 320 can receive, from the administrator device, a second request for second information utilizing the card view link of the second interactive graphical user interface. In response, the notification system 320 can generate a third interactive graphical user interface comprising an interactive card view comprising the card data, vendor data, and providing card options. The notification system 320 can also transmit the third interactive graphical user interface to the administrator device for display. In some examples, the notification system 320 can also receive, from the administrator device, updated card options utilizing the interactive card view of the third interactive graphical user interface. These card options can include, for example, changes to the prefunded amounts, changes to the expiration, changes to “exact pay” settings, and the like. The notification system 320 can then apply the updated card options to correct the reason the prefunded virtual card was declined. For example, if the “exact pay” settings are changes, the first transaction can go through if the reason for decline was that the prefunded virtual card previously required an exact pay amount. The notification system 320 can then update the first interactive graphical user interface to clear the first transaction from the interactive list view, update the second interactive graphical user interface to indicate on the detailed view the first transaction is resolved, and transmit the updated first interactive graphical user interface and the updated second interactive graphical user interface to the administrator device for display.

Regarding the machine learning application of the present invention described above, the notification system 320 can retrieve past declination data and determine, using a heuristic machine learning model, an automatic resolution based on the past declination data and the reason. Non-limiting example resolutions are described above with reference to Table 1. Past declination data can be mapped to reasons for one or more virtual cards for one client or a plurality of clients. The notification system 320 can automatically apply the automatic resolution to correct the reason the prefunded virtual card was declined, update the second interactive graphical user interface showing the reason and the automatic resolution, and transmit the updated second interactive graphical user interface to the administrator device for display.

In some examples, the notification system 320 can retrieve past declination data and determine, using a heuristic machine learning model, an automatic resolution based on the past declination data and the reason. The system can then generate a suggestion to a user based on the automatic resolution and update the second interactive graphical user interface showing the suggestion and a button allowing the user to correct the reason the prefunded virtual card was declined using the suggestion. The system can then transmit the updated second interactive graphical user interface to the administrator device for display.

FIG. 1B is a flow diagram illustrating an exemplary method 150 for virtual card decline notifications, in accordance with certain embodiments of the disclosed technology. The steps of method 150 can be performed by one or more components of the system 400 (e.g., notification system 320, web server 410 of prefunded virtual card system 408, or user device 402), as described in more detail with respect to FIGS. 3 and 4. Method 150 is similar to method 100 in many respects. In one example, the system described in method 150 can be beneficial to rank certain declined messages in an order (e.g., by severity) and re-rank the messages as the declined messages are resolved by the client. Again, and as will be described in greater detail below, a machine learning model can also learn from the ordering, re-ranking, and resolution to preempt future decline notifications needing to be resolved by the administrator.

In block 152, the notification system 320 can receive declination data regarding a first transaction using a prefunded virtual card. This step is similar to the step described above in block 102. In block 154, the notification system 320 can determine, from the declination data, a reason the prefunded virtual card was declined using rules-based decisioning, the reason categorized as a first type of one or more types.

In block 156, the notification system 320 can, responsive to the reason being categorized as the first type, determine a ranking of one or more previous declined transactions using prefunded cards and the first transaction using the reason and the declination data. The ranking can be performed, for example, based on severity, as described above with respect to method 100. In block 158, the notification system 320 can notify an administrator device regarding the first transaction. In block 160, the notification system 320 can generate a first interactive graphical user interface comprising an interactive notification list view comprising the previous declined transactions and the first transaction in a first order according to the ranking.

In block 162, the notification system 320 can transmit the first interactive graphical user interface to the administrator device for display. In block 164, the notification system 320 can receive, from the administrator device, an indication that one or more transactions had been resolved. In block 166, the notification system 320 can determine an updated ranking of the one or more previous declined transactions and the first transaction compensating for the indication.

In block 168, the notification system 320 can generate an updated first interactive graphical user interface including an updated interactive notification list view that includes the previous declined transactions and the first transaction in a second order according to the updated ranking. In block 170, the notification system 320 can transmit the updated first interactive graphical user interface to the administrator device for display.

Method 150 can end after block 170, or the method can include one or more of the steps described herein, including the steps described for method 100 in FIG. 1A. In some examples, method 150 can include receiving, from the first interactive graphical user interface, administrator data regarding types of previous declined transactions selected from the interactive notification list view. The method can include determining whether a user prefers to open notifications regarding the previous declined transactions of the first type. Further, and responsive to determining that the user prefers to open notifications regarding the previous declined transactions of the first type, the method can include silencing notifications for the user for future declined transactions other than the first type. Responsive to the reason being categorized as a second type, the method can include generating a third interactive graphical user interface comprising the interactive notification list view showing previous declined transactions using prefunded virtual cards and the reason, and transmitting the third interactive graphical user interface to the administrator device.

In some examples, method 150 can retrieving past declination data. The method can include determining, using a heuristic machine learning model, an automatic resolution based on the past declination data and the reason, automatically applying the automatic resolution to correct the reason the prefunded virtual card was declined, updating the first interactive graphical user interface showing the reason and the automatic resolution, and transmitting the updated first interactive graphical user interface to the administrator device. These steps can be similar to those described above with reference to method 100 in FIG. 1A.

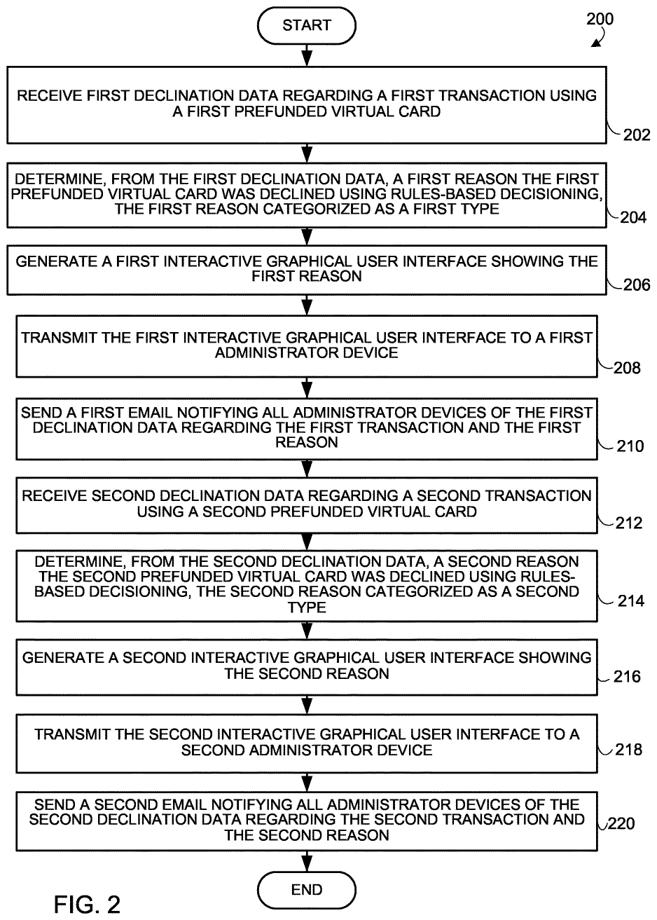

FIG. 2 is a flow diagram illustrating an exemplary method 200 for virtual card decline notifications, in accordance with certain embodiments of the disclosed technology. The steps of method 200 can be performed by one or more components of the system 400 (e.g., notification system 320, web server 410 of prefunded virtual card system 408, or user device 402), as described in more detail with respect to FIGS. 3 and 4. Method 200 of FIG. 2 can be similar to method 100 of FIG. 1A. In one example, the system described in method 200 can be beneficial to examples wherein certain client administrators are tasked with solving certain types of declines. The system (e.g., notification system 320) can classify the reason the prefunded virtual card was declined and, based on the reason, generate a graphical user interface for a specific administrator (e.g., on a specific administrator device).

Referring now to method 200, in block 202, the notification system 320 can receive first declination data regarding a first transaction using a first prefunded virtual card. This step is similar to the step described above in block 102 and 152. In block 204, the notification system 320 can determine, from the first declination data, a first reason the first prefunded virtual card was declined using rules-based decisioning, the first reason categorized as a first type. This step is similar to the step described above in block 154.

In block 206, the notification system 320 can, responsive to first reason being categorized as the first type, generate a first interactive graphical user interface showing the first reason. In block 208, the notification system 320 can transmit the first interactive graphical user interface to a first administrator device. In block 210, the notification system 320 can send a first email notifying all administrator devices of the first declination data regarding the first transaction and the first reason.

In block 212, the notification system 320 can receive second declination data regarding a second transaction using a second prefunded virtual card. As described above, this can be a situation wherein a single client has issued a plurality of prefunded cards for various limited purposes. In block 214, the notification system 320 can determine, from the second declination data, a second reason the second prefunded virtual card was declined using rules-based decisioning, the second reason categorized as a second type. In block 216, the notification system 320 can, responsive to the second reason being categorized as the second type, generate a second interactive graphical user interface showing the second reason.

In block 218, the notification system 320 can transmit the second interactive graphical user interface to a second administrator device. In block 220, the notification system 320 can send a second email notifying all administrator devices of the second declination data regarding the second transaction and the second reason. The first administrator device can be associated with responding to declines of the first type, and the second administrator device can be associated with responding to declines of the second type. The different types can be, for example, the different “reasons” described above with reference to Table 1 and its related disclosure.

Method 200 can end after block 220, or the method can include one or more of the steps described herein, including the steps described for method 100 in FIG. 1A and method 150 in FIG. 1B. In some examples, method 200 can include receiving administrator device data. The administrate device data can include hardware characteristics and/or login information on the deice that is associated with a particular administrator of the client. Method 200 can include determining, from the administrator device data that the first administrator device is responding to declines of the first type and that the second administrator device is responding to declines of the second type. Method 200 can include receiving third declination data regarding a third transaction using a third prefunded virtual card. Method 200 can include determining, from the third declination data, a third reason the third prefunded virtual card was declined using rules-based decisioning, the third reason categorized as the second type. Responsive to the third reason being categorized as the second type, the method can include generating a third interactive graphical user interface showing the third reason, transmitting the third interactive graphical user interface to the second administrator device, and sending a third email notifying all administrator devices of the third declination data regarding the third transaction and the third reason.

In some examples, method 200 can include receiving administrator device data, as described above. Method 200 can include determining, from the administrator device data, that the first administrator device has not responded to the first transaction after a predetermined time threshold. Method 200 can include generating a fourth interactive graphical user interface showing the first reason. Method 200 can include transmitting the fourth interactive graphical user interface to the second administrator device.

Regarding the machine learning application of the present invention described above, the notification system 320 in some implementations of method 200 can retrieve past declination data. The notification system 320 can determine, using a heuristic machine learning model, an automatic resolution based on the past declination data and the second reason. The notification system 320 can automatically apply the automatic resolution to correct the second reason the first prefunded virtual card was declined. The notification system 320 can update the second interactive graphical user interface showing the second reason and the automatic resolution. The notification system 320 can transmit the updated second interactive graphical user interface to the second administrator device.

FIG. 3 is a block diagram of an example notification system 320 used to receive data regarding transactions, transmit the various notifications, and perform the machine learning examples described herein, according to an example implementation of the disclosed technology. According to some embodiments, the user device 402 and web server 410, as depicted in FIG. 4 and described below, can have a similar structure and components that are similar to those described with respect to notification system 320 shown in FIG. 3. As shown, the notification system 320 can include a processor 310, an input/output (I/O) device 370, a memory 330 containing an operating system (OS) 340 and a program 350. In certain example implementations, the notification system 320 can be a single server or can be configured as a distributed computer system including multiple servers or computers that interoperate to perform one or more of the processes and functionalities associated with the disclosed embodiments. In some embodiments notification system 320 can be one or more servers from a serverless or scaling server system. In some embodiments, the notification system 320 can further include a peripheral interface, a transceiver, a mobile network interface in communication with the processor 310, a bus configured to facilitate communication between the various components of the notification system 320, and a power source configured to power one or more components of the notification system 320.

A peripheral interface, for example, can include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface can include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver can be configured to communicate with compatible devices and ID tags when they are within a predetermined range. A transceiver can be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface can provide access to a cellular network, the Internet, or another wide-area or local area network. In some embodiments, a mobile network interface can include hardware, firmware, and/or software that allow(s) the processor(s) 310 to communicate with other devices via wired or wireless networks, whether local or wide area, private or public, as known in the art. A power source can be configured to provide an appropriate alternating current (AC) or direct current (DC) to power components.

The processor 310 can include one or more of a microprocessor, microcontroller, digital signal processor, co-processor or the like or combinations thereof capable of executing stored instructions and operating upon stored data. The memory 330 can include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein can be implemented as a combination of executable instructions and data stored within the memory 330.

The processor 310 can be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 can constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 can be a single core processor that is configured with virtual processing technologies. In certain embodiments, the processor 310 can use logical processors to simultaneously execute and control multiple processes. The processor 310 can implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the notification system 320 can include one or more storage devices configured to store information used by the processor 310 (or other components) to perform certain functions related to the disclosed embodiments. In one example, the notification system 320 can include the memory 330 that includes instructions to enable the processor 310 to execute one or more applications, such as server applications, network communication processes, and any other type of application or software known to be available on computer systems. Alternatively, the instructions, application programs, etc. can be stored in an external storage or available from a memory over a network. The one or more storage devices can be a volatile or non-volatile, magnetic, semiconductor, tape, optical, removable, non-removable, or other type of storage device or tangible computer-readable medium.

The notification system 320 can include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the notification system 320 can include the memory 330 that can include one or more programs 350 to perform one or more functions of the disclosed embodiments. For example, in some embodiments, the notification system 320 can additionally manage dialogue and/or other interactions with the customer via a program 350.

The processor 310 can execute one or more programs 350 located remotely from the notification system 320. For example, the notification system 320 can access one or more remote programs that, when executed, perform functions related to disclosed embodiments.

The memory 330 can include one or more memory devices that store data and instructions used to perform one or more features of the disclosed embodiments. The memory 330 can also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 can include software components that, when executed by the processor 310, perform one or more processes consistent with the disclosed embodiments. In some embodiments, the memory 330 can include a notification system database 360 for storing related data to enable the notification system 320 to perform one or more of the processes and functionalities associated with the disclosed embodiments.

The notification system database 360 can include stored data relating to status data (e.g., average session duration data, location data, idle time between sessions, and/or average idle time between sessions) and historical status data. According to some embodiments, the functions provided by the notification system database 360 can also be provided by a database that is external to the notification system 320, such as the database 416 as shown in FIG. 4.

The notification system 320 can also be communicatively connected to one or more memory devices (e.g., databases) locally or through a network. The remote memory devices can be configured to store information and can be accessed and/or managed by the notification system 320. By way of example, the remote memory devices can be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The notification system 320 can also include one or more I/O devices 370 that can comprise one or more interfaces for receiving signals or input from devices and providing signals or output to one or more devices that allow data to be received and/or transmitted by the notification system 320. For example, the notification system 320 can include interface components, which can provide interfaces to one or more input devices, such as one or more keyboards, mouse devices, touch screens, track pads, trackballs, scroll wheels, digital cameras, microphones, sensors, and the like, that enable the notification system 320 to receive data from a user (such as, for example, via the user device 402).

In examples of the disclosed technology, the notification system 320 can include any number of hardware and/or software applications that are executed to facilitate any of the operations. The one or more I/O interfaces can be utilized to receive or collect data and/or user instructions from a wide variety of input devices. Received data can be processed by one or more computer processors as desired in various implementations of the disclosed technology and/or stored in one or more memory devices.

The notification system 320 can contain programs that train, implement, store, receive, retrieve, and/or transmit one or more machine learning models. Machine learning models can include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models can include an ensemble model (e.g., a model comprised of a plurality of models). In some embodiments, training of a model can terminate when a training criterion is satisfied. Training criterion can include a number of epochs, a training time, a performance metric (e.g., an estimate of accuracy in reproducing test data), or the like. The notification system 320 can be configured to adjust model parameters during training. Model parameters can include weights, coefficients, offsets, or the like. Training can be supervised or unsupervised.

The notification system 320 can be configured to train machine learning models by optimizing model parameters and/or hyperparameters (hyperparameter tuning) using an optimization technique, consistent with disclosed embodiments. Hyperparameters can include training hyperparameters, which can affect how training of the model occurs, or architectural hyperparameters, which can affect the structure of the model. An optimization technique can include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The notification system 320 can be configured to optimize statistical models using known optimization techniques.

While the notification system 320 has been described as one form for implementing the techniques described herein, other, functionally equivalent, techniques can be employed. For example, some or all of the functionality implemented via executable instructions can also be implemented using firmware and/or hardware devices such as application specific integrated circuits (ASICs), programmable logic arrays, state machines, etc. Furthermore, other implementations of the notification system 320 can include a greater or lesser number of components than those illustrated.

FIG. 4 is a block diagram of an example system that can be used to view and interact with prefunded virtual card system 408, according to an example implementation of the disclosed technology. The components and arrangements shown in FIG. 4 are not intended to limit the disclosed embodiments as the components used to implement the disclosed processes and features can vary. As shown, prefunded virtual card system 408 can interact with a user device 402 via a network 406. In certain example implementations, the prefunded virtual card system 408 can include a local network 412, a notification system 320, a web server 410, and a database 416.

In some embodiments, a user, such as an administrator of the client as described above, can operate the user device 402 (referred to above as a first administrator device). The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the prefunded virtual card system 408. In some embodiments, the user device 402 can include or incorporate electronic communication devices for hearing or vision impaired users. In some examples, the system 400 can also include a second user device 404 (referred to above as a second administrator device) operated by a second user, such as a second administrator of the client as described above. The first user device 402 and second user device 404 can be substantially similar. According to some embodiments, the user devices 402 and/or 404 can include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 can be of any suitable type, including individual connections via the internet such as cellular or WiFi networks. In some embodiments, the network 406 can connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted can be personal or confidential, security concerns can dictate one or more of these types of connections be encrypted or otherwise secured. In some embodiments, however, the information being transmitted can be less personal, and therefore the network connections can be selected for convenience over security.

The network 406 can include any type of computer networking arrangement used to exchange data. For example, the network 406 can be the Internet, a private data network, virtual private network (VPN) using a public network, and/or other suitable connection(s) that enable(s) components in the system 400 environment to send and receive information between the components of the system 400. The network 406 can also include a PSTN and/or a wireless network.

The prefunded virtual card system 408 can be associated with and optionally controlled by one or more entities such as a business, corporation, individual, partnership, or any other entity that provides one or more of goods, services, and consultations to individuals such as customers. In some embodiments, the prefunded virtual card system 408 can be controlled by a third party on behalf of another business, corporation, individual, partnership. The prefunded virtual card system 408 can include one or more servers and computer systems for performing one or more functions associated with products and/or services that the organization provides.

Web server 410 can include a computer system configured to generate and provide one or more websites accessible to customers, as well as any other individuals involved in access system 408's normal operations. Web server 410 can include a computer system configured to receive communications from user device 402 via for example, a mobile application, a chat program, an instant messaging program, a voice-to-text program, an SMS message, email, or any other type or format of written or electronic communication. Web server 410 can have one or more processors 422 and one or more web server databases 424, which can be any suitable repository of website data. Information stored in web server 410 can be accessed (e.g., retrieved, updated, and added to) via local network 412 and/or network 406 by one or more devices or systems of system 400. In some embodiments, web server 410 can host websites or applications that can be accessed by the user device 402. For example, web server 410 can host a financial service provider website that a user device can access by providing an attempted login that are authenticated by the notification system 320. According to some embodiments, web server 410 can include software tools, similar to those described with respect to user device 402 above, that can allow web server 410 to obtain network identification data from user device 402. The web server can also be hosted by an online provider of website hosting, networking, cloud, or backup services, such as Microsoft Azure™ or Amazon Web Services™.

The local network 412 can include any type of computer networking arrangement used to exchange data in a localized area, such as WiFi, Bluetooth™, Ethernet, and other suitable network connections that enable components of the prefunded virtual card system 408 to interact with one another and to connect to the network 406 for interacting with components in the system 400 environment. In some embodiments, the local network 412 can include an interface for communicating with or linking to the network 406. In other embodiments, certain components of the prefunded virtual card system 408 can communicate via the network 406, without a separate local network 406.

The prefunded virtual card system 408 can be hosted in a cloud computing environment (not shown). The cloud computing environment can provide software, data access, data storage, and computation. Furthermore, the cloud computing environment can include resources such as applications (apps), VMs, virtualized storage (VS), or hypervisors (HYP). User device 402 can be able to access prefunded virtual card system 408 using the cloud computing environment. User device 402 can be able to access prefunded virtual card system 408 using specialized software. The cloud computing environment can eliminate the need to install specialized software on user device 402.

In accordance with certain example implementations of the disclosed technology, the prefunded virtual card system 408 can include one or more computer systems configured to compile data from a plurality of sources the notification system 320, web server 410, and/or the database 416. The notification system 320 can correlate compiled data, analyze the compiled data, arrange the compiled data, generate derived data based on the compiled data, and store the compiled and derived data in a database such as the database 416. According to some embodiments, the database 416 can be a database associated with an organization and/or a related entity that stores a variety of information relating to customers, transactions, ATM, and business operations. The database 416 can also serve as a back-up storage device and can contain data and information that is also stored on, for example, database 360, as discussed with reference to FIG. 3.

### Example Use Case

The following example use case describes an example of a typical user flow pattern. This section is intended solely for explanatory purposes and not in limitation.

Thomas owns a construction business and sub-contracts out various jobs to vendors. For each job he contracts out, he prefers to keep his vendors on a budget specifically tailored for the job, so Thomas works with his financial institution to provide limited-purpose virtual cards that can be used by his vendors only for those jobs.

Thomas receives a job request to build a house, and receives estimates from various plumbing vendors to complete the plumbing part of the project. He selects one vendor who quoted the plumbing job at $14,260. Thomas then requests a single virtual card that can be used for three months and is prefunded at $14,260. He then provides this virtual card to his plumbing vendor to complete the job.

Weeks pass, and the plumber attempts to buy piping from an online retailer for $1,500, but at this point the virtual card only has $1,200 remaining. In response, the payment to that piping merchant is declined, and Thomas receives a push notification on his mobile phone that indicates, in an interactive graphical user interface, that the plumber's transaction was declined. Thomas then clicks on the particular decline message regarding the plumber's failure to complete the transaction, and a second interactive graphical user interface is displayed that includes a detailed view of the first transaction showing the reason for the decline, the declination data (including the overage amount of $300), the virtual card number, and a card view link. He clicks on the card view link, notices the plumber needs $300 to complete the job, and Thomas clicks, in the interactive graphical user interface of the card view link, an option to provide an additional $300 to the plumber. This information allows Thomas to keep track of unexpected overages during the project.

In some examples, disclosed systems or methods can involve one or more of the following clauses:

Clause 1: A notification system comprising: one or more processors; memory in communication with the one or more processors and storing instructions that are configured to cause the notification system to: receive declination data regarding a first transaction using a prefunded virtual card; determine, from the declination data, a reason the prefunded virtual card was declined using rules-based decisioning; categorize the reason into one of one or more predetermined categories; responsive to the reason being categorized in a select group of the one or more predetermined categories: generate a first interactive graphical user interface comprising an interactive list view showing one or more previous declined transactions using prefunded virtual cards; transmit the first interactive graphical user interface to an administrator device for display; receive, from the administrator device, a first request for first information regarding the first transaction by selecting the first transaction utilizing the first interactive graphical user interface; generate a second interactive graphical user interface comprising a detailed view of the first transaction showing the reason, the declination data, card data, a card balance, and a card view link; and transmit the second interactive graphical user interface the administrator device for display.

Clause 2: The notification system of clause 1, wherein the first interactive graphical user interface and the second interactive graphical user interface are part of an application on the administrator device.

Clause 3: The notification system of clause 1, wherein the predetermined categories for the reason comprise when a transaction is above a card limit, when exact pay is required, when there is an expiration date mismatch, when the prefunded virtual card is expired, when there is a CVV code mismatch, or combinations thereof.

Clause 4: The notification system of clause 1, wherein the memory stores further instructions that are configured to cause the notification system to: determine a severity rating for each of the one or more previous declined transactions based on the predetermined category; and organize the interactive list view based on the severity rating.

Clause 5: The notification system of clause 1, wherein the memory stores further instructions that are configured to cause the notification system to: determine a numerical order of virtual card numbers associated with the one or more previous declined transactions; and organize the interactive list view based on the numerical order of virtual card numbers.

Clause 6: The notification system of clause 1, wherein the detailed view further comprises a resolution recommendation based on the reason.

Clause 7: The notification system of clause 1, wherein the memory stores further instructions that are configured to cause the notification system to: receive, from the administrator device, a second request for second information utilizing the card view link of the second interactive graphical user interface; generate a third interactive graphical user interface comprising an interactive card view comprising the card data, vendor data, and providing card options; and transmit the third interactive graphical user interface to the administrator device for display.

Clause 8: The notification system of clause 7, wherein the memory stores further instructions that are configured to cause the notification system to: receive, from the administrator device, updated card options utilizing the interactive card view of the third interactive graphical user interface; apply the updated card options to correct the reason the prefunded virtual card was declined; update the first interactive graphical user interface to clear the first transaction from the interactive list view; update the second interactive graphical user interface to indicate on the detailed view the first transaction is resolved; and transmit the updated first interactive graphical user interface and the updated second interactive graphical user interface to the administrator device for display.

Clause 9: The notification system of clause 1, wherein the memory stores further instructions that are configured to cause the notification system to: retrieve past declination data; determine, using a heuristic machine learning model, an automatic resolution based on the past declination data and the reason; automatically apply the automatic resolution to correct the reason the prefunded virtual card was declined; update the second interactive graphical user interface showing the reason and the automatic resolution; and transmit the updated second interactive graphical user interface to the administrator device for display.

Clause 10: The notification system of clause 1, wherein the memory stores further instructions that are configured to cause the notification system to: retrieve past declination data; determine, using a heuristic machine learning model, an automatic resolution based on the past declination data and the reason; generate a suggestion to a user based on the automatic resolution; update the second interactive graphical user interface showing the suggestion and a button allowing the user to correct the reason the prefunded virtual card was declined using the suggestion; and transmit the updated second interactive graphical user interface to the administrator device for display.

Clause 11: The notification system of clause 1, wherein the first interactive graphical user interface and the second interactive graphical user interface are a part of an email, a push notification, a message, or combinations thereof.

Clause 12: A notification system comprising: one or more processors; memory in communication with the one or more processors and storing instructions that are configured to cause the notification system to: receive first declination data regarding a first transaction using a first prefunded virtual card; determine, from the first declination data, a first reason the first prefunded virtual card was declined using rules-based decisioning, the first reason categorized as a first type; responsive to the first reason being categorized as the first type: generate a first interactive graphical user interface showing the first reason; transmit the first interactive graphical user interface to a first administrator device; send a first email notifying all administrator devices of the first declination data regarding the first transaction and the first reason; receive second declination data regarding a second transaction using a second prefunded virtual card; determine, from the second declination data, a second reason the second prefunded virtual card was declined using rules-based decisioning, the second reason categorized as a second type; responsive to the second reason being categorized as the second type: generate a second interactive graphical user interface showing the second reason; transmit the second interactive graphical user interface to a second administrator device; and send a second email notifying all administrator devices of the second declination data regarding the second transaction and the second reason.

Clause 13: The notification system of clause 12, wherein the first administrator device is associated with responding to declines of the first type, and wherein the second administrator device is associated with responding to declines of the second type.

Clause 14: The notification system of clause 12, wherein the memory stores further instructions that are configured to cause the notification system to: receive administrator device data; determine, from the administrator device data, that the first administrator device is responding to declines of the first type and that the second administrator device is responding to declines of the second type; receive third declination data regarding a third transaction using a third prefunded virtual card; determine, from the third declination data, a third reason the third prefunded virtual card was declined using rules-based decisioning, the third reason categorized as the second type; responsive to the third reason being categorized as the second type: generate a third interactive graphical user interface showing the third reason; transmit the third interactive graphical user interface to the second administrator device; and send a third email notifying all administrator devices of the third declination data regarding the third transaction and the third reason.

Clause 15: The notification system of clause 12, wherein the memory stores further instructions that are configured to cause the notification system to: receive administrator device data; and determine, from the administrator device data, that the first administrator device has not responded to the first transaction after a predetermined time threshold; generate a fourth interactive graphical user interface showing the first reason; and transmit the fourth interactive graphical user interface to the second administrator device.

Clause 16: The notification system of clause 12, wherein the memory stores further instructions that are configured to cause the notification system to: retrieve past declination data; determine, using a heuristic machine learning model, an automatic resolution based on the past declination data and the second reason; automatically apply the automatic resolution to correct the second reason the first prefunded virtual card was declined; update the second interactive graphical user interface showing the second reason and the automatic resolution; and transmit the updated second interactive graphical user interface to the second administrator device.

Clause 17: A notification system comprising: one or more processors; memory in communication with the one or more processors and storing instructions that are configured to cause the notification system to: receive declination data regarding a first transaction using a prefunded virtual card; determine, from the declination data, a reason the prefunded virtual card was declined using rules-based decisioning, the reason categorized as a first type of one or more types; responsive to the reason being categorized as the first type: determine a ranking of one or more previous declined transactions using prefunded cards and the first transaction using the reason and the declination data; notify an administrator device regarding the first transaction; generate a first interactive graphical user interface comprising an interactive notification list view comprising the previous declined transactions and the first transaction in a first order according to the ranking; transmit the first interactive graphical user interface to the administrator device for display; receive, from the administrator device, an indication that one or more transactions had been resolved; determine an updated ranking of the one or more previous declined transactions and the first transaction compensating for the indication; generate an updated first interactive graphical user interface comprising an updated interactive notification list view comprising the previous declined transactions and the first transaction in a second order according to the updated ranking; and transmit the updated first interactive graphical user interface to the administrator device for display.

Clause 18: The notification system of clause 17, wherein the memory stores further instructions that are configured to cause the notification system to: receive, from the first interactive graphical user interface, administrator data regarding types of previous declined transactions selected from the interactive notification list view; determine whether a user prefers to open notifications regarding the previous declined transactions of the first type; and responsive to determining that the user prefers to open notifications regarding the previous declined transactions of the first type: silence notifications for the user for future declined transactions other than the first type.

Clause 19: The notification system of clause 18, wherein the memory stores further instructions that are configured to cause the notification system to: responsive to the reason being categorized as a second type: generate a third interactive graphical user interface comprising the interactive notification list view showing previous declined transactions using prefunded virtual cards and the reason; and transmit the third interactive graphical user interface to the administrator device.

Clause 20: The notification system of clause 17, wherein the memory stores further instructions that are configured to cause the notification system to: retrieve past declination data; determine, using a heuristic machine learning model, an automatic resolution based on the past declination data and the reason; automatically apply the automatic resolution to correct the reason the prefunded virtual card was declined; update the first interactive graphical user interface showing the reason and the automatic resolution; and transmit the updated first interactive graphical user interface to the administrator device.

The features and other aspects and principles of the disclosed embodiments can be implemented in various environments. Such environments and related applications can be specifically constructed for performing the various processes and operations of the disclosed embodiments or they can include a general-purpose computer or computing platform selectively activated or reconfigured by program code to provide the necessary functionality. Further, the processes disclosed herein can be implemented by a suitable combination of hardware, software, and/or firmware. For example, the disclosed embodiments can implement general purpose machines configured to execute software programs that perform processes consistent with the disclosed embodiments. Alternatively, the disclosed embodiments can implement a specialized apparatus or system configured to execute software programs that perform processes consistent with the disclosed embodiments. Furthermore, although some disclosed embodiments can be implemented by general purpose machines as computer processing instructions, all or a portion of the functionality of the disclosed embodiments can be implemented instead in dedicated electronics hardware.

The disclosed embodiments also relate to tangible and non-transitory computer readable media that include program instructions or program code that, when executed by one or more processors, perform one or more computer-implemented operations. The program instructions or program code can include specially designed and constructed instructions or code, and/or instructions and code well-known and available to those having ordinary skill in the computer software arts. For example, the disclosed embodiments can execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms can be used as building blocks for a framework, however certain implementations of the system can autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component can be, but is not limited to being, a process running on a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, can be repeated, or may not necessarily need to be performed at all, according to some embodiments or implementations of the disclosed technology.

These computer-executable program instructions can be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions can also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology can provide for a computer program product, including a computer-usable medium having a computer-readable program code or program instructions embodied therein, said computer-readable program code adapted to be executed to implement one or more functions specified in the flow diagram block or blocks. Likewise, the computer program instructions can be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices can include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology can be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features can alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for dynamically triaging declined virtual card transactions, the method comprising:
receiving, at a notification system comprising one or more processors, declination data regarding a plurality of declined transactions using prefunded virtual cards, wherein each prefunded virtual card comprises a string of digits configured for digital online transactions;
determining, by the notification system using rules-based decisioning, a decline reason for each of the plurality of declined transactions;
computing, by the notification system, a severity rating for each of the plurality of declined transactions based on the decline reason;
generating, by the notification system, a first interactive graphical user interface comprising an interactive list view displaying the plurality of declined transactions organized in a first order according to the computed severity ratings;
transmitting the first interactive graphical user interface to an administrator device for display;
receiving, from the administrator device via the first interactive graphical user interface, an indication that at least one of the plurality of declined transactions has been resolved;
dynamically re-computing, by the notification system, updated severity ratings for remaining unresolved declined transactions based on the received indication;
generating an updated first interactive graphical user interface comprising an updated interactive list view displaying the remaining unresolved declined transactions reorganized in a second order according to the updated severity ratings; and
transmitting the updated first interactive graphical user interface to the administrator device for display, thereby dynamically updating the display to reflect current triage priorities.

2. The method of claim 1, wherein computing the severity rating comprises evaluating at least one of: an amount by which a transaction exceeds a prefunded card limit, a duration beyond an expiration date, or a number of repeated decline attempts.

3. The method of claim 1, further comprising:
receiving, from the administrator device, a selection of a specific declined transaction from the interactive list view;
generating a second interactive graphical user interface comprising a detailed view of the selected declined transaction showing the decline reason, the declination data, card data, a card balance, and a card view link; and
transmitting the second interactive graphical user interface to the administrator device for display.

4. The method of claim 1, further comprising:
training a machine learning model based on administrator interactions with the first interactive graphical user interface, wherein the administrator interactions comprise selections of declined transactions from the interactive list view; and
adjusting future severity rating computations based on the trained machine learning model to reflect learned administrator triage preferences.

5. The method of claim 4, wherein adjusting future severity rating computations comprises increasing severity ratings for decline reasons that correspond to declined transactions previously selected by the administrator.

6. A notification system comprising:
one or more processors; and
memory in communication with the one or more processors and storing instructions that, when executed, cause the notification system to:
receive declination data regarding a plurality of declined transactions using prefunded virtual cards;
determine a ranking of the plurality of declined transactions based on the declination data;
generate a first interactive graphical user interface comprising an interactive list view displaying the plurality of declined transactions in a first order according to the ranking;
transmit the first interactive graphical user interface to an administrator device for display;
receive, from the administrator device, an indication that at least one declined transaction has been resolved;
determine an updated ranking of remaining declined transactions compensating for the indication;
generate an updated first interactive graphical user interface comprising an updated interactive list view displaying the remaining declined transactions in a second order according to the updated ranking; and
transmit the updated first interactive graphical user interface to the administrator device for display.

7. The notification system of claim 6, wherein the instructions further cause the notification system to:
determine a severity rating for each of the plurality of declined transactions based on a predetermined category; and
wherein the ranking is based on the severity rating.

8. The notification system of claim 6, wherein the instructions further cause the notification system to:
determine, from the declination data, a reason each prefunded virtual card was declined using rules-based decisioning; and
categorize each reason into one of one or more predetermined categories.

9. The notification system of claim 8, wherein the predetermined categories comprise when a transaction is above a card limit, when exact pay is required, when there is an expiration date mismatch, when the prefunded virtual card is expired, when there is a CVV code mismatch, or combinations thereof.

10. The notification system of claim 6, wherein the instructions further cause the notification system to:
receive, from the administrator device, a selection of a specific declined transaction from the interactive list view;
generate a second interactive graphical user interface comprising a detailed view of the selected declined transaction showing a decline reason, the declination data, card data, a card balance, and a card view link; and
transmit the second interactive graphical user interface to the administrator device for display.

11. The notification system of claim 10, wherein the instructions further cause the notification system to:
receive, from the administrator device, updated card options utilizing the second interactive graphical user interface;
apply the updated card options to correct a reason the prefunded virtual card was declined;
update the first interactive graphical user interface to clear the selected declined transaction from the interactive list view; and
transmit the updated first interactive graphical user interface to the administrator device for display.

12. The notification system of claim 6, wherein the instructions further cause the notification system to:
train a machine learning model based on administrator interactions with the first interactive graphical user interface; and
adjust future ranking determinations based on the trained machine learning model.

13. The notification system of claim 6, wherein the first interactive graphical user interface and the updated first interactive graphical user interface are part of an application on the administrator device.

14. The notification system of claim 6, wherein the first interactive graphical user interface and the updated first interactive graphical user interface are a part of an email, a push notification, a message, or combinations thereof.

15. A non-transitory computer-readable medium storing instructions that, when executed by one or more processors, cause the one or more processors to perform operations comprising:
receiving declination data regarding a plurality of declined transactions using prefunded virtual cards;
determining a ranking of the plurality of declined transactions based on the declination data;
generating a first interactive graphical user interface comprising an interactive list view displaying the plurality of declined transactions in a first order according to the ranking;
transmitting the first interactive graphical user interface to an administrator device for display;
receiving, from the administrator device, an indication that at least one declined transaction has been resolved;
determining an updated ranking of remaining declined transactions compensating for the indication;
generating an updated first interactive graphical user interface comprising an updated interactive list view displaying the remaining declined transactions in a second order according to the updated ranking; and
transmitting the updated first interactive graphical user interface to the administrator device for display.

16. The non-transitory computer-readable medium of claim 15, wherein the operations further comprise:
computing a severity rating for each of the plurality of declined transactions based on a decline reason; and
wherein the ranking is based on the computed severity ratings.

17. The non-transitory computer-readable medium of claim 15, wherein the operations further comprise:
receiving, from the administrator device, a selection of a specific declined transaction from the interactive list view;
generating a second interactive graphical user interface comprising a detailed view of the selected declined transaction; and
transmitting the second interactive graphical user interface to the administrator device for display.

18. The non-transitory computer-readable medium of claim 15, wherein the operations further comprise:
training a machine learning model based on administrator interactions with the first interactive graphical user interface; and
adjusting future ranking determinations based on the trained machine learning model to reflect learned administrator triage preferences.

19. The non-transitory computer-readable medium of claim 18, wherein the administrator interactions comprise selections of declined transactions from the interactive list view, and wherein adjusting future ranking determinations comprises increasing rankings for decline reasons that correspond to declined transactions previously selected by the administrator.

20. The non-transitory computer-readable medium of claim 15, wherein the prefunded virtual cards each comprise a string of digits configured for digital online transactions.
